(19) United States
(12) Patent Application Publication
(10) Pub. No.: US 2007/0290973 A1
(43) Pub. Date: Dec. 20, 2007

(54) STRUCTURE OF PIXEL CIRCUIT FOR DISPLAY AND DRIVING METHOD THEREOF

(75) Inventor: YEN-LIN WEI, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AU OPTRONICS CORPORATION, Hsinchu (TW)

(21) Appl. No.: 11/559,909

(22) Filed: Nov. 15, 2006

(30) Foreign Application Priority Data
Jun. 14, 2006 (TW) 95121183

(51) Int. Cl. G09G 3/36

(52) U.S. Cl. 345/92

(57) ABSTRACT

A pixel circuit including a first transistor, a coupling capacitor, a second transistor, and a luminescent element is provided. The first transistor is used as a switch. The coupling capacitor stores a coupling voltage and transmits the coupling voltage to the gate of the second transistor for compensating a drift of the threshold voltage of the second transistor. The second transistor provides a driving current for driving the luminescent element to emit light.

### CROSS-REFERENCE TO RELATED APPLICATION

This application claims the priority benefit of Taiwan application serial no. 95121183, filed Jun. 14, 2006. All disclosure of the Taiwan application is incorporated herein by reference.

### BACKGROUND OF THE INVENTION

1. Field of the Invention

The present invention relates to the structure of a pixel circuit and a driving method thereof. More particularly, the present invention relates to the structure of a pixel circuit for a display and a driving method thereof.

2. Description of Related Art

Nowadays the transmission of image information has mostly transformed from analog transmission into digital transmission along with the rapid development of computer performance and the evolvement of the Internet and multimedia technology. Video or image devices are becoming more and more light-weighted and slim-sized to meet the modern life style. Even though traditional cathode ray tube (CRT) display still has the advantage of lower cost, such display is too bulky, and the radiation produced by a CRT display may harm the viewer's eyes.

Accordingly, the recently developed flat panel display (FPD), such as liquid crystal display (LCD), organic light emitting diode (OLED) display, field emission display (FED), projection display, digital light processing (DLP) display, liquid crystal on silicon (LCOS) display, or plasma display panel (PDP), has become the market-leading display product.

The OLED display is also referred to as organic electro-luminescent display (OELD) which is self-emissive. The OLED has such characteristics as low DC voltage driving, high brightness, high efficiency, high contrast, light-weight, and slimness, and the emitting color thereof has high degrees of freedom from red, green, and blue the three original colors to white. Thus, the OLED is referred to as the developing focus of new generation FPDs.

Besides having advantages of light-weight, slimness, and high resolution of LCD, and active light emission, fast response, and power-saving cold light source of LED, OLED technology further has such advantages as broader view angle, better color contrast, and lower cost. Thus, OLED can be broadly applied to mobile phones, digital cameras, and personal digital assistants (PDAs).

In terms of driving methods, OLEDs can be categorized into passive matrix driving OLEDs and active matrix driving OLEDs. The passive matrix OLED has a simple structure, thus the cost thereof is low; however, the disadvantage of the passive matrix OLED is that such OLED is not suitable for displaying high resolution images, and the problems of increased power consumption, shortened device lifetime, and bad display performance will be caused when such OLED is developed towards large-sized panel. Active matrix OLED has such outstanding advantages as broad view angle, high brightness, and fast response time besides being applied to large-sized active matrix driving; however, the fabricating cost thereof is slightly higher than that of the passive matrix OLED.

FPDs can also be categorized into voltage driving FPDs and current driving FPDs according to different driving method thereof. Voltage driving FPDs are generally applied to thin film transistor liquid crystal displays (TFT-LCDs), wherein different voltages are input to data lines to achieve different grey scales, so as to achieve the purpose of full color. Voltage driving TFT-LCDs have such advantages as technology maturity, stableness, and low cost. Current driving FPDs are generally applied to OLED displays, wherein different currents are input to data lines to achieve different grey scales, so as to achieve full color. However, new circuits and ICs need to be developed for such method of current driving pixel, and thus the cost thereof is very high.

Accordingly, the cost will be reduced considerably if the voltage driving circuit of TFT-LCD is used for driving OLEDs. However, when driving OLEDs with the voltage driving circuit of TFT-LCD, drift of the threshold voltage of the driving thin film transistor may be caused after operating for a long time, and accordingly the threshold voltage will increases gradually. The formula of the drain current of the thin film transistor in saturation area is: Ids=(½)×μn×Cox×(W/L)×(V_{gs}−Vₜₕ)², wherein the electron mobility rate μn and the gate capacitance per unit area Cox are constant values, Vₜₕ is the threshold voltage of the thin film transistor, W is the channel width of the thin film transistor, and L is the channel length of the thin film transistor. It can be understood from the formula that when the threshold voltage increases, the driving current passing through the drain and the source of the driving thin film transistor decreases. Since the driving current is used for driving the OLED to emit light, the brightness of the OLED will decrease when the driving current decreases.

To be understood more clearly, FIG. 1 illustrates a conventional pixel circuit of OLED. Referring to FIG. 1, the pixel circuit 100 includes a driving circuit 101 and an OLED 102. The driving circuit 101 includes a switching thin film transistor 103, a capacitor 105, and a driving thin film transistor 107. The first source/drain of the switching thin film transistor 103 is coupled to the data voltage Vdata, the gate thereof is coupled to the scanning voltage Vscan, and the second source/drain thereof is coupled to one terminal of the capacitor 105 and the gate of the driving thin film transistor 107. The first source/drain of the driving thin film transistor 107 is coupled to another terminal of the capacitor 105 and the supply voltage VDD, the second source/drain thereof is coupled to the positive electrode of the OLED 102, and the negative electrode of the OLED 102 is grounded. The driving thin film transistor 107 is used for generating a driving current for driving the OLED 102 to emit light.

It can be understood from the coupling situation of the pixel circuit 100, as shown in FIG. 1, that when the scanning voltage is set to high voltage level, the switching thin film transistor 103 is turned on. When the scanning voltage is set to low voltage level, the switching thin film transistor 103 is turned off. Besides, it should be noted that the period wherein a high voltage level and a low voltage level of the scanning voltage appear is referred to as the time of a frame, which is generally 1/60 second, which is, the frequency of the scanning voltage is 60 Hz.

Next, when the scanning voltage is set to high voltage level and the data voltage is also high voltage level, the gate voltage Vg of the driving thin film transistor 107 becomes positive value and is maintained as a positive voltage during the entire frame time. It is noted that when the driving thin film transistor 107 works with the gate/source voltage Vgs being positive for long time, drift of the threshold voltage of the driving thin film transistor 107 will be produced and which increases gradually. Such result will cause the driving current passing through the first source/drain and the second source/drain of the driving thin film transistor 107 to decrease, and therefore the brightness of the OLED 102 is reduced. As a result, the lifetime of the display panel is shortened.

To resolve the aforementioned problems, FIG. 2 illustrates a pixel circuit for compensating threshold voltage. Referring to FIG. 2, in the pixel circuit 200, a digital circuit driven with inverter principle is adopted along with a coupling capacitor 203 for storing and compensating the threshold voltage, and the pixel brightness is determined by light emitting duration. However, the characteristic of the inverter composed of a single thin film transistor 201 is not very ideal, and the definition of the grey scales of the display panel has to be considered additionally. FIG. 3 illustrates another pixel circuit for compensating threshold voltage. Referring to FIG. 3, in pixel circuit 300, four thin film transistors are used for compensating the threshold voltage of the driving thin film transistor, and the grey scales of the display panel are determined based on the data current Idata, however, the aperture ratio is reduced even though the drift of the threshold voltage is compensated.

In overview, generally more than 3 thin film transistors have to be added in conventional technology to compensate the drift of the threshold voltage of the driving thin film transistor 107 in the pixel circuit 100, which reduces the pixel aperture ratio of the display panel considerably. The fabricating cost will be increased if polysilicon process is adopted to avoid the aperture ratio being affected by the number of transistors or if the foregoing inverter driving principle is used for compensating the threshold voltage.

### SUMMARY OF THE INVENTION

Accordingly, the present invention is directed to a pixel circuit, a display, and a driving method of display panel for compensating a drift of the threshold voltage of a driving thin film transistor without affecting the pixel aperture ratio of the display panel.

According to the present invention, the pixel circuit includes a first transistor, a coupling capacitor, a second transistor, and a luminescent element. The first source/drain of the first transistor is coupled to the supply voltage (VDD), the gate thereof is used for receiving a scanning voltage. The coupling capacitor has a first terminal and a second terminal, wherein the first terminal is used for receiving a data voltage and the second terminal is coupled to the second source/drain of the first transistor. The gate of the second transistor is coupled to the second terminal of the coupling capacitor, and the first source/drain thereof is coupled to the supply voltage. The luminescent element has a positive electrode and a negative electrode, wherein the positive electrode is coupled to the second source/drain of the second transistor, and the negative electrode is grounded.

The present invention further provides a pixel circuit including a luminescent element, a first transistor, a coupling capacitor, and a second transistor. The luminescent element has a positive electrode, which is coupled to the supply voltage, and a negative electrode. The first source/drain of the first transistor is coupled to the negative electrode of the luminescent element, and the gate thereof is used for receiving a scanning voltage. The coupling capacitor has a first terminal and a second terminal, wherein the first terminal is used for receiving a data voltage, and the second terminal is coupled to the second source/drain of the first transistor. The gate of the second transistor is coupled to the second terminal of the coupling capacitor, the first source/drain thereof is coupled to the negative electrode of the luminescent element, and the second source/drain thereof is grounded.

According to an embodiment of the present invention, the first transistor and the second transistor may be fabricated with amorphous silicon, polysilicon, or microcrystalline silicon process, and the first transistor and the second transistor may be N-type thin film transistors; the luminescent element may be an organic light emitting diode (OLED).

The present invention further provides a pixel circuit including a luminescent element, a first transistor, a coupling capacitor, and a second transistor. The luminescent element has a positive electrode, which is coupled to the supply voltage, and a negative electrode. The first source/drain of the first transistor is coupled to the negative electrode of the luminescent element, and the second source/drain thereof is grounded. The coupling capacitor has a first terminal and a second terminal, wherein the first terminal is used for receiving a data voltage, and the second terminal is coupled to the gate of the first transistor. The gate of the second transistor is used for receiving the scanning voltage, the first source/drain thereof is coupled to the second terminal of the coupling capacitor, and the second source/drain thereof is grounded.

The present invention further provides a pixel circuit including a luminescent element, a first transistor, a coupling capacitor, and a second transistor. The luminescent element has a positive electrode and a negative electrode, wherein the negative electrode is grounded. The first source/drain of the first transistor is coupled to the supply voltage, and the second source/drain thereof is coupled to the positive electrode of the luminescent element. The coupling capacitor has a first terminal and a second terminal, wherein the first terminal is used for receiving a data voltage, and the second terminal is coupled to the gate of the first transistor. The gate of the second transistor is used for receiving a scanning voltage, the first source/drain thereof is coupled to the second terminal of the coupling capacitor, and the second source/drain thereof is coupled to the positive electrode of the luminescent element.

According to an embodiment of the present invention, the first transistor and the second transistor may be fabricated with amorphous silicon, polysilicon, or microcrystalline silicon process, and the first transistor and the second transistor may be P-type thin film transistors; the luminescent element may be an OLED.

According to another aspect of the present invention, a display including a gate driving device, a source driving device, a system switch, and a display panel is provided. The gate driving device has a plurality of gate lines for receiving a basic timing, and the gate driving device sequentially outputs a scanning voltage to each of the gate lines. The source driving device has a plurality of source lines for receiving image data, and the source driving device outputs data voltages through the source lines. The system switch is coupled to the supply voltage. The display panel is coupled to the gate driving device and the source driving device. The display panel has a plurality of pixel circuits, and the pixel circuits are respectively disposed at the intersections of the gate lines and the source lines. Each of the pixel circuits includes a first transistor, a coupling capacitor, a second transistor, and a luminescent element. The first source/drain of the first transistor is coupled to the supply voltage through the system switch, and the gate thereof receives a scanning voltage through one of the gate. lines. The coupling capacitor has a first terminal and a second terminal, wherein the first terminal receives the data voltage through one of the source lines, and the second terminal is coupled to the second source/drain of the first transistor. The gate of the second transistor is coupled to the second terminal of the coupling capacitor, and the first source/drain thereof is coupled to the supply voltage through the system switch. The luminescent element has a positive electrode and a negative electrode, wherein the positive electrode is coupled to the second source/drain of the second transistor, and the negative electrode is grounded.

According to another embodiment of the present invention, each of the pixel circuits in the display panel includes a luminescent element, a first transistor, a coupling capacitor, and a second transistor. The luminescent element has a positive electrode and a negative electrode, wherein the positive electrode is coupled to the supply voltage through the system switch. The first source/drain of the first transistor is coupled to the negative electrode, and the gate thereof receives a scanning voltage through one of the gate lines. The coupling capacitor has a first terminal and a second terminal, wherein the first terminal receives a data voltage through one of the source lines, and the second terminal is coupled to the second source/drain of the first transistor. The gate of the second transistor is coupled to the second terminal of the coupling capacitor, the first source/drain thereof is coupled to the negative electrode of the luminescent element, and the second source/drain thereof is grounded.

According to an embodiment of the present invention, the first transistor and the second transistor may be fabricated with amorphous silicon, polysilicon, or microcrystalline silicon process, and the first transistor and the second transistor may be N-type thin film transistors; the luminescent element may be an OLED.

According to another embodiment of the present invention, each of the pixel circuits in the display panel includes a luminescent element, a first transistor, a coupling capacitor, and a second transistor. The luminescent element has a positive electrode, which is coupled to the supply voltage, and a negative electrode. The first source/drain of the first transistor is coupled to the negative electrode of the luminescent element, and the second source/drain thereof is grounded. The coupling capacitor has a first terminal and a second terminal, wherein the first terminal is used for receiving a data voltage, and the second terminal is coupled to the gate of the first transistor. The gate of the second transistor is used for receiving a scanning voltage, the first source/drain thereof is coupled to the second terminal of the coupling capacitor, and the second source/drain thereof is grounded.

According to another embodiment of the present invention, each of the pixel circuits in the display panel includes a luminescent element, a first transistor, a coupling capacitor, and a second transistor. The luminescent element has a positive electrode and a negative electrode, and the negative electrode is grounded. The first source/drain of the first transistor is coupled to the supply voltage, and the second source/drain thereof is coupled to the positive electrode of the luminescent element. The coupling capacitor has a first terminal and a second terminal, wherein the first terminal is used for receiving a data voltage, and the second terminal is coupled to the gate of the first transistor. The gate of the second transistor is used for receiving a scanning voltage, the first source/drain thereof is coupled to the second terminal of the coupling capacitor, and the second source/drain thereof is coupled to the positive electrode of the luminescent element.

According to an embodiment of the present invention, the first transistor and the second transistor may be fabricated with amorphous silicon, polysilicon, or microcrystalline silicon process, and the first transistor and the second transistor may be P-type thin film transistors; the luminescent element may be an OLED.

According to another embodiment of the present invention, the system switch sends the supply voltage to the first sources/drains of all the second transistors in the display panel when the scanning voltage is a low voltage level.

According to another embodiment of the present invention, the system switch sends the supply voltage to the positive electrodes of all the luminescent elements in the display panel when the scanning voltage is a low voltage level.

According to another embodiment of the present invention, the system switch may be a MOS transistor, a diode, or a thin film transistor.

According to another embodiment of the present invention, the time when a display panel displays an image data is divided into a write time and a display time. The display panel does not display image during the write time, while the display panel displays image during the display time. During the write time, the source driving device provides a data voltage to each of the pixel circuits, so as to define the voltage stored in the coupling capacitor; during the display time, the source driving device provides a constant voltage to simultaneously drive the pixel circuits in the display panel.

According to yet another aspect of the present invention, a method for driving a display panel is provided, wherein the display panel has a plurality of pixel circuits arranged in an array. According to the present invention, the display panel sequentially turns on each of the enabled pixel circuits and transmits a data voltage to each of the pixel circuits when the display panel operates in the write time. Next, the display panel transmits a constant voltage to all the pixel circuits to simultaneously drive the pixel circuits when the display panel operates in the display time.

According to an embodiment of the present invention, when the display panel operates in the write time, the display panel sequentially transmits a scanning voltage to each column of pixel circuits to sequentially turns on each column of pixel circuits, and then transmits a data voltage to each of the turned-on pixel circuits; when the display panel operates in the display time, the display panel receives a constant voltage and compares the constant voltage and the data voltage of each of the pixel circuits for defining a display grey scale. Finally, the display panel simultaneously drives the pixel circuits therein.

According to an embodiment of the present invention, whether a pixel circuit is in the write time or in the display time is determined according to a voltage level state of the scanning voltage. The display panel is in write time when the voltage level state is high voltage level, and the display panel is in display time when the voltage level state is low voltage level.

According to the present invention, the coupling effect of the coupling capacitor is adopted for compensating the threshold voltage of the second transistor, and further the driving current for driving the luminescent element can be sustained, so that the brightness of the luminescent element is not affected by drift of the threshold voltage. Moreover, compensation to the threshold voltage of the second transistor is achieved with only two thin film transistors and one coupling capacitor in the entire pixel circuit, and furthermore, the pixel aperture ratio of the display panel is increased, the fabricating cost of the display panel is reduced, and the lifetime of the display panel is extended.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a conventional OLED pixel circuit.

FIG. 2 illustrates a pixel circuit for compensating threshold voltage.

FIG. 3 illustrates another pixel circuit for compensating threshold voltage.

FIG. 4 illustrates a display according to an embodiment of the present invention.

FIG. 5 illustrates a pixel circuit in a display panel according to an embodiment of the present invention.

FIG. 6 illustrates a pixel circuit for a display according to another embodiment of the present invention.

FIG. 7 illustrates a pixel circuit for a display according to another embodiment of the present invention.

FIG. 8 illustrates a pixel circuit for a display according to another embodiment of the present invention.

FIG. 9 is a timing diagram of a pixel circuit according to an embodiment of the present invention.

FIG. 10 is a timing diagram of a display according to an embodiment of the present invention.

FIG. 11 is a flowchart illustrating the method for driving a display panel according to an exemplary embodiment of the present invention.

FIG. 12 is a flowchart illustrating the write time according to an embodiment of the present invention.

FIG. 13 is a flowchart illustrating the display time according to an embodiment of the present invention.

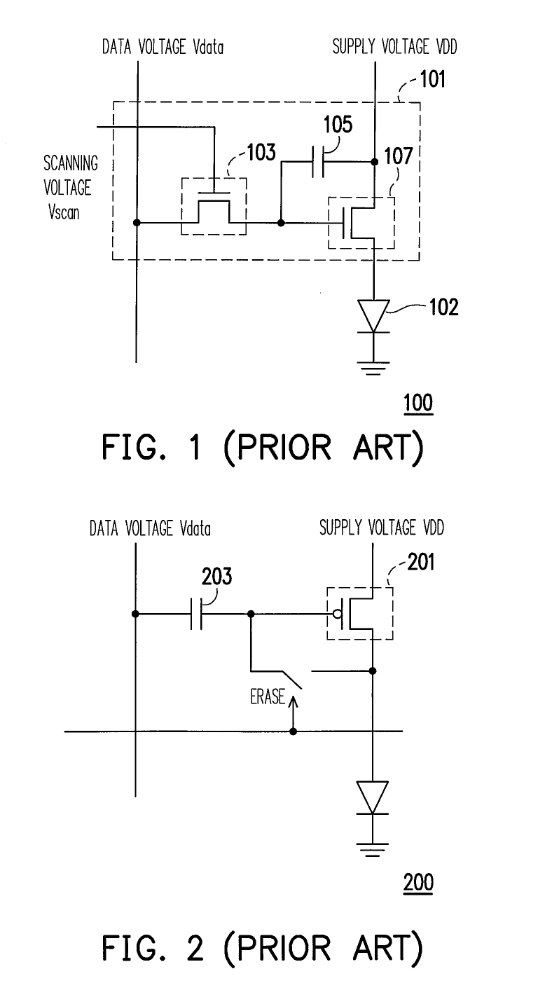

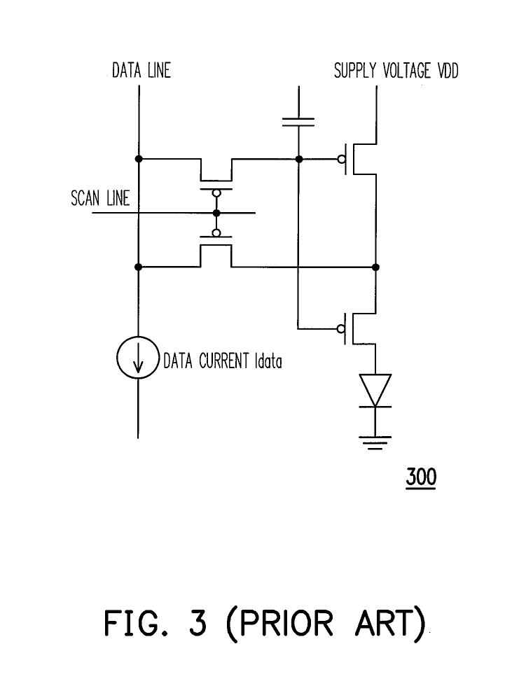

### DESCRIPTION OF EMBODIMENTS

In conventional technology, a drift of the threshold voltage of the driving thin film transistor may be caused when the driving thin film transistor works for a long time, which may further reduce the driving current produced by the driving transistor, and to sustain the required driving current, more than three transistors are required in the pixel circuit, which may reduce the pixel aperture ratio of the display panel, accordingly the brightness of the display panel may be reduced in both cases. To resolve the foregoing problems, the present invention provides a pixel circuit, a display, and a method for driving a display panel.

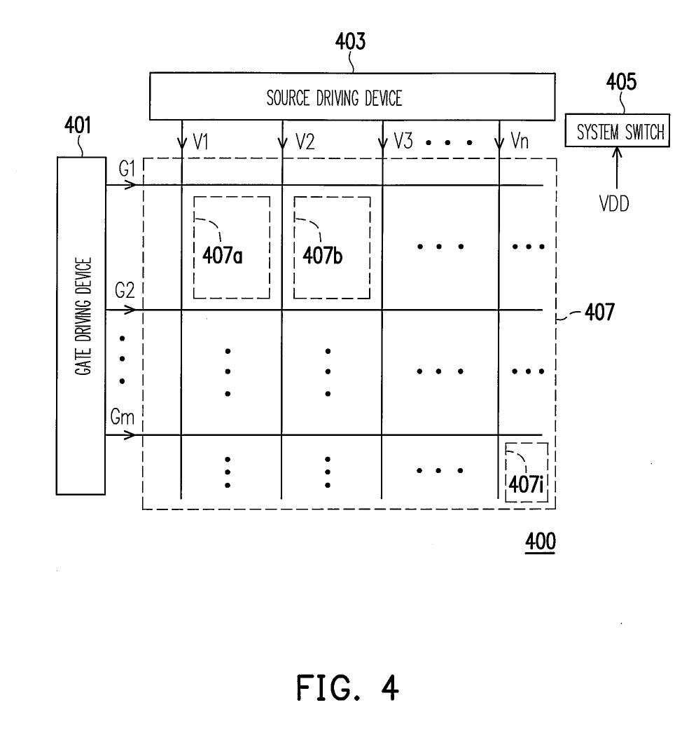

FIG. 4 illustrates a display according to an embodiment of the present invention. Referring to FIG. 4, the display 400 includes a gate driving device 401, a source driving device 403, a system switch 405, and a display panel 407. The gate driving device 401 has a plurality of gate lines G1-Gm for receiving a basic timing, and the gate driving device 401 sequentially outputs a scanning voltage Vscan to each of the gate lines G1-Gm. The source driving device 403 has a plurality of source lines V1-Vn for receiving image data, and the source driving device 403 outputs a data voltage Vdata through the source lines V1-Vn. The system switch 405 is coupled to the supply voltage VDD. The display panel 407 is coupled to the gate driving device 401 and the source driving device 403, and the display panel 407 has a plurality of pixel circuits 407a-407i respectively disposed at the intersections of the gate lines G1-Gm and the source lines V1-Vn.

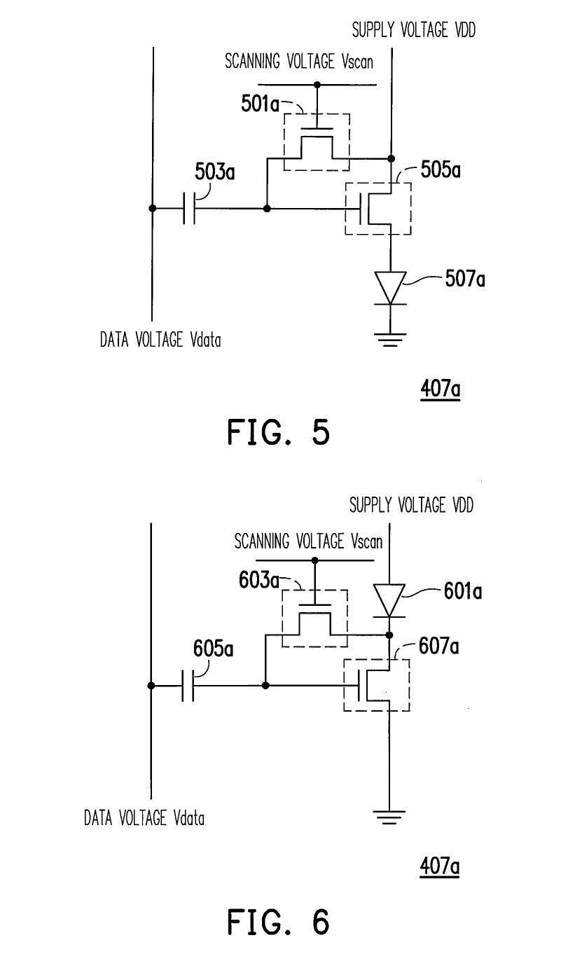

FIG. 5 illustrates the pixel circuit in the display panel according to the present embodiment. Referring to both FIG. 4 and FIG. 5, the pixel circuit 407a in the present embodiment includes a first transistor 501a, a coupling capacitor 503a, a second transistor 505a, and a luminescent element 507a. The first source/drain of the first transistor 501a is coupled to the supply voltage VDD through the system switch 405, and the gate thereof receives a scanning voltage Vscan through one of the gate lines G1-Gm. The coupling capacitor 503a has a first terminal and a second terminal, wherein the first terminal receives a data voltage Vdata through one of the source lines V1-Vn, and the second terminal is coupled to the second source/drain of the first transistor 501a. The gate of the second transistor 505a is coupled to the second terminal of the coupling capacitor 503a, and the first source/drain thereof is coupled to the supply voltage VDD through the system switch 405. The luminescent element 507a has a positive electrode and a negative electrode, wherein the positive electrode is coupled to the second source/drain of the second transistor 505a, and the negative electrode thereof is grounded.

In the present embodiment, the structures of the pixel circuits 407a-407i in the display panel 407 are all the same as the structure of the pixel circuit 407a. It can be known based on the pixel circuit 407a that the pixel circuits 407a-407i in the display panel 407 include the first transistors 501a-501i, the coupling capacitors 503a-503i, the second transistors 505a-505i, and the luminescent elements 507a-507i.

FIG. 6 illustrates a pixel circuit for a display according to another embodiment of the present invention. The pixel circuits 407a-407i in the display panel 407 further include luminescent elements 601a-601i, first transistors 603a-603i, coupling capacitors 605a-605i, and second transistors 607a-607i. The luminescent elements 601a-601i have positive electrodes and negative electrodes, and the positive electrodes are coupled to the supply voltage VDD through the system switch 405. The first sources/drains of the first transistors 603a-603i are coupled to the negative electrodes of the luminescent elements 601a-601i, and the gates thereof receive a scanning voltage Vscan through one of the gate lines G1-Gm respectively. The coupling capacitors 605a-605i have first terminals and second terminals, wherein the first terminals receive a data voltage Vdata through one of the source lines V1-Vn respectively, and the second terminals are coupled to the second sources/drains of the first transistors 603a-603i. The gates of the second transistors 607a-607i are coupled to the second terminals of the coupling capacitors 605a-605i, the first sources/drains thereof are coupled to the negative electrodes of the luminescent elements 601a-601i, and the second sources/drains thereof are grounded.

The first transistors 501a-501i, 603a-603i, and the second transistors 505a-505i, 607a-607i in foregoing embodiments may be fabricated with amorphous silicon, polysilicon, or microcrystalline silicon process, the first transistors 501a-501i, 603a-603i, and the second transistors 505a-505i, 607a-607i may be N-type thin film transistors, and the luminescent elements 507a-507i and 601a-601i may be organic light emitting diodes (OLEDs).

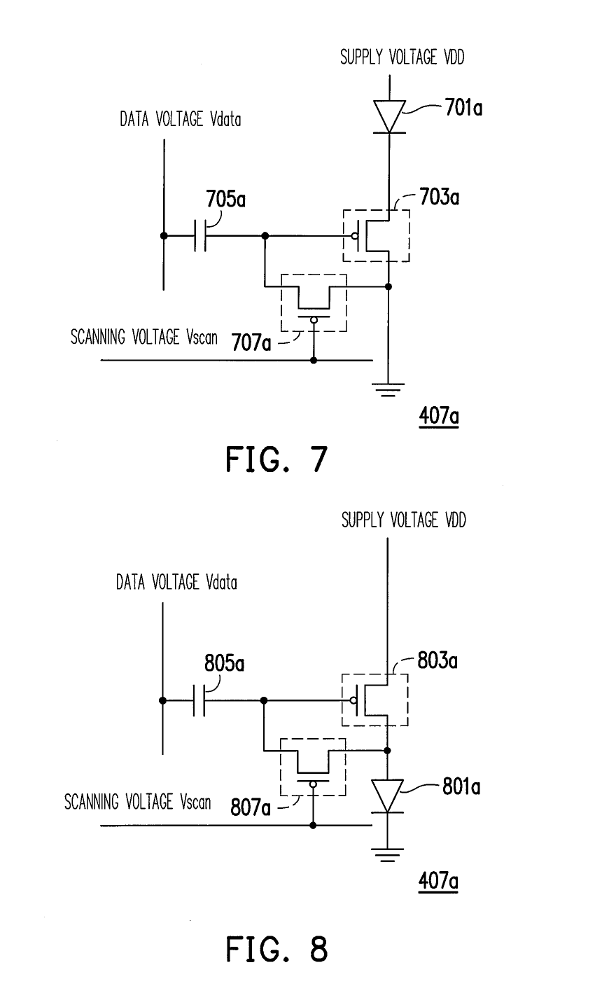

FIG. 7 illustrates a pixel circuit for a display according to another embodiment of the present invention. The pixel circuits 407a-407i in the display panel 407 further include luminescent elements 701a-701i, first transistors 703a-703i, coupling capacitors 705a-705i, and second transistors 707a-707i. The luminescent elements 701a-701i have positive electrodes and negative electrodes, and the positive electrodes are coupled to the supply voltage VDD through the system switch 405. The first sources/drains of the first transistors 703a-703i are coupled to the negative electrodes of the luminescent elements 701a-701i, and the second sources/drains thereof are grounded. The coupling capacitors 705a-705i have first terminals and second terminals, wherein the first terminals receive a data voltage Vdata through one of the source lines V1-Vn respectively, and the second terminals are coupled to the gates of the first transistors 703a-703i. The gates of the second transistors 707a-707i receive a scanning voltage Vscan through one of the gate lines G1-Gm respectively, the first sources/drains thereof are coupled to the second terminals of the coupling capacitors 705a-705i, and the second sources/drains thereof are grounded.

FIG. 8 illustrates a pixel circuit for a display according to another embodiment of the present invention. The pixel circuits 407a-407i in the display panel 407 further include luminescent elements 801a-801i, first transistors 803a-803i, coupling capacitors 805a-805i, and second transistors 807a-807i. The luminescent elements 801a-801i have positive electrodes and negative electrodes, and the negative electrodes are grounded. The first sources/drains of the first transistors 803a-803i are coupled to the supply voltage VDD, and the second sources/drains thereof are coupled to the positive electrodes of the luminescent elements 801a-801i. The coupling capacitors 805a-805i have first terminals and second terminals, wherein the first terminals receive a data voltage Vdata through one of the source lines V1-Vn respectively, and the second terminals are coupled to the gates of the first transistors 803a-803i. The gates of the second transistors 807a-807i receive a scanning voltage Vscan through one of the gate lines G1-Gm respectively, the first sources/drains thereof are coupled to the second terminals of the coupling capacitors 805a-805i, and the second sources/drains thereof are coupled to the positive electrodes of the luminescent elements 801a-801i.

According to an exemplary embodiment of the present invention, the system switch 405 may be a MOS transistor, a thin film transistor, a diode, or any switching device.

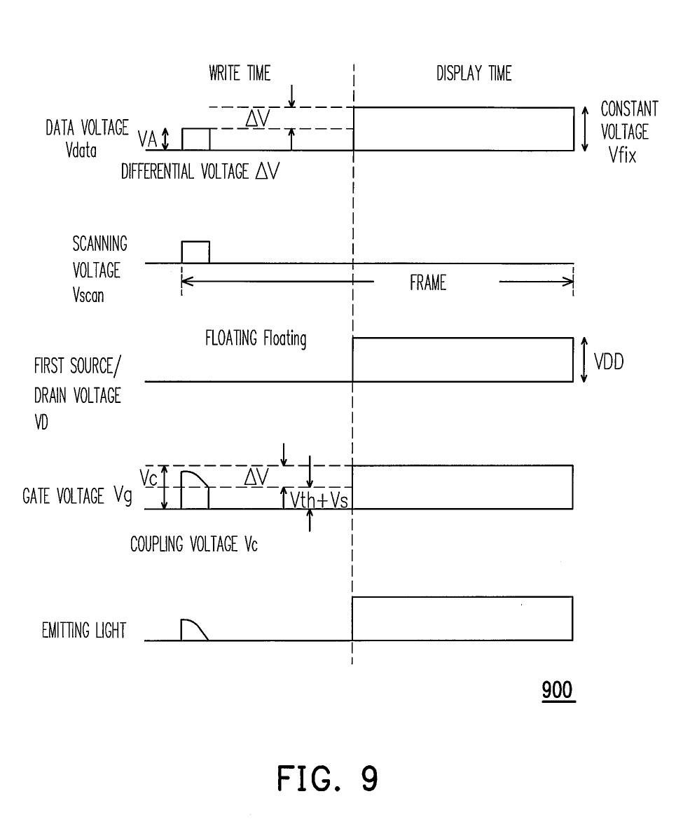

FIG. 9 is a timing diagram of the pixel circuit according to the present embodiment. The present invention will be described with reference to the pixel circuit 407a illustrated in FIG. 5. Similarly, the description can be applied to the pixel circuits 407a in FIG. 6, FIG. 7, and FIG. 8. Referring to both FIG. 5 and FIG. 9, in the timing diagram 900 of the pixel circuit 407a, the period wherein a high voltage level and a lower voltage level of the scanning voltage Vscan appear is referred to as the time of a frame, and a frame time is divided into a write time and a display time. Next, during the write time and the selecting time of the pixel circuit 407a, the gate of the first transistor 501a receives the scanning voltage Vscan and outputs a high voltage level to turn on the first transistor 501a, and meanwhile, the data voltage Vdata transmits a write voltage VA to couple a voltage Vc to the gate of the second transistor 505a through the coupling capacitor 503a. Since the first transistor 501a is turned on, the gate and the first source/drain of the second transistor 505a are coupled together, the gate voltage Vg and the first source/drain voltage of the second transistor 505a are equal to the coupling voltage Vc, and here the second transistor 505a operates as a diode. Thus, the second transistor 505a is turned on constantly when the coupling voltage Vc is greater than the threshold voltage Vth of the second transistor 505a plus the threshold voltage Vs of the luminescent element 507a (i.e. the threshold voltage Vth of the pixel circuit 407a).

However, the first source/drain of the second transistor 505a is in floating state during the write time, thus, when the second transistor 505a is turned on, the gate voltage Vg of the second transistor 505a decreases, and the second transistor 505a is only turned off when the gate voltage Vg of the second transistor 505a is equal to the threshold voltage Vth of the pixel circuit 407a. Thus, the gate voltage Vg of the second transistor 505a is defined happen to be the threshold voltage Vth of the pixel circuit 407a, that is, the threshold voltage Vth of the pixel circuit 407a is compensated.

In the present embodiment, the voltage value stored in the coupling capacitor 503a is the write voltage VA minus the threshold voltage Vth of the pixel circuit 407a, and which is used for receiving and storing the data voltage Vdata so that the driving current for driving the luminescent element 507a is not affected by the drift of the threshold voltage Vth of the second transistor 505a, and for sustaining the driving current for driving the luminescent element 507a. The second transistor 505a is used for providing the driving current to the luminescent element 507a.

Next, during the write time but not the selecting time of the pixel circuit 407a, the scanning voltage Vscan outputs a low voltage level to turn off the first transistor 501a. Thus, the gate voltage Vg of the second transistor 505a does not have an effective discharge path; accordingly, the voltage value stored in the coupling capacitor 503a is not affected no matter what write voltage VA the data voltage Vdata provides the pixel circuit 407a.

For example, when the voltage value stored in the coupling capacitor 503a is 2V, that is, the first terminal of the coupling capacitor 503a has the write voltage VA (for example, 4V), and the second terminal has the gate voltage Vg (for example, 2V) of the second transistor 505a. During the write time but not the selecting time of the pixel circuit 407a, the data voltage Vdata inputs a write voltage VA, which is, for example, 10V. In the situation that the gate voltage Vg of the second transistor 505a does not have an effective discharge path, the gate voltage Vg may also increase to 8V, and thus the voltage value stored in the coupling capacitor 503a is still 2V. Accordingly, during the write time but not the selecting time of the pixel circuit 407a, the voltage value stored in the coupling capacitor 503a will not be affected. It should be known to those skilled in the art that the effect described above is a capacitor coupling effect.

During the display time, the first source/drain of the second transistor 505a is coupled to the supply voltage VDD, and the scanning voltage Vscan outputs a low voltage level to turn off the first transistor 501a. Here the data voltage Vdata provides a constant voltage Vfix so that the coupling capacitor 503a couples a differential voltage ΔV to the gate of the second transistor 505a, and the luminescent element 507a emits light according to the differential voltage ΔV. Thus, the grey scale of the pixel circuit 407a is determined according to the differential voltage ΔV.

In the present embodiment, the differential voltage ΔV is equal to the constant voltage Vfix minus the write voltage VA and is used for defining the grey scale of the pixel circuit 407a.

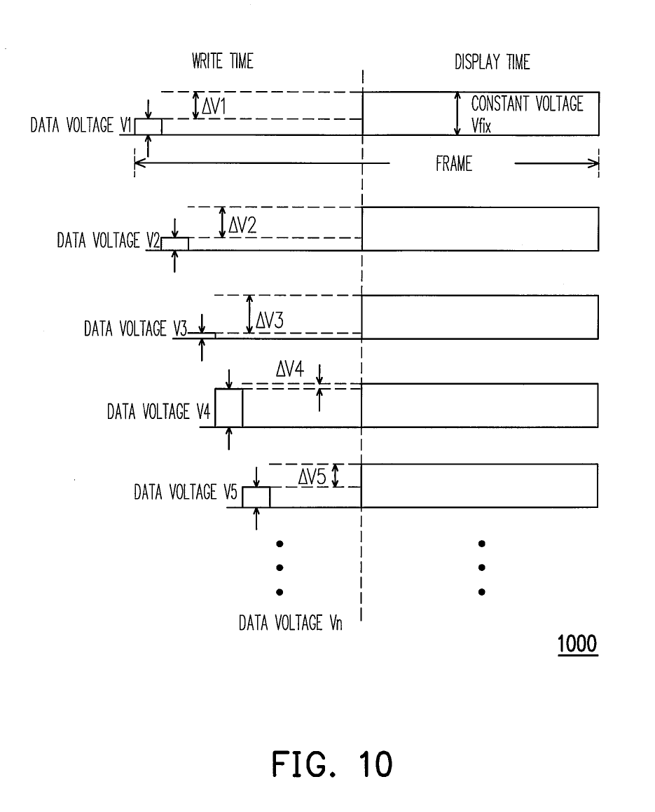

FIG. 10 is a timing diagram of the display according to the present embodiment. Referring to FIG. 4, FIG. 5, and FIG. 10 all together, in the timing diagram 1000 of the display, the period wherein a high voltage level and a low voltage level of the scanning voltage Vscan appear is referred to as the time of a frame, and a frame time is divided into a write time and a display time. The operation principles of the pixel circuits 407a-407i during the write time and the selecting times of the pixel circuits 407a-407i in the display panel 407 are all the same as that of the pixel circuit 407a.

Next, the source driving device 403 provides data voltages V1-Vn to the pixel circuits 407a-407i, so that the coupling capacitors 503a-503i in the pixel circuits 407a-407i respectively couple a voltage value to the gates of the second transistors 505a-505i, and then after discharging for some time, differential voltages ΔV1−ΔVn are respectively stored in the coupling capacitors 503a-503i. The luminescent elements 507a-507i emit light for a short time according to the values of the differential voltages ΔV1−ΔVn at the time of discharging, however, the entire brightness of the display panel 407 is not affected since this period is very short.

In addition, during the display time, the first sources/drains of the second transistors 505a-505i are coupled to the supply voltage VDD through the system switch 405, and the gate driving device 401 outputs a low voltage level to turn off the first transistors 501a-501i, here the source driving device 403 provides a constant voltage Vfix for simultaneously driving the pixel circuits 407a-407i in the display panel 407. The grey scales of the pixel circuits 407a-407i in the display panel 407 are determined according to the differential voltages ΔV1−ΔVn.

In the present embodiment, the system switch 405 sends the supply voltage VDD to the first sources/drains of all the second transistors 505a-505i in the display panel 407 when the scanning voltage Vscan is a low voltage level.

In the present embodiment, the time when the display panel 407 is displaying an image data is divided into a write time and a display time. The display panel dose not display image during the write time, while the display panel 407 displays image during the display time.

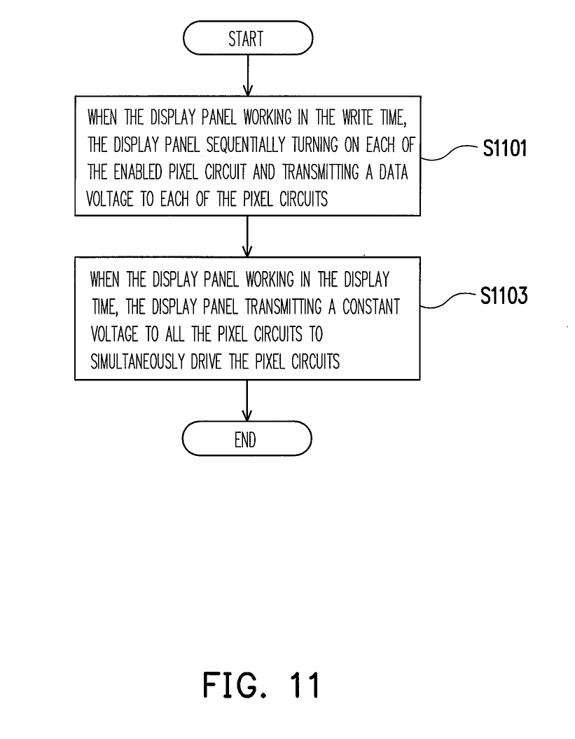

FIG. 11 is a flowchart illustrating the method for driving a display panel according to an embodiment of the present invention, wherein the display panel has a plurality of pixel circuits arranged in an array. First, as in step S1101, the display panel sequentially turns on each of the enabled pixel circuits and transmits a data voltage to each of the pixel circuits when the display panel operates in the write time. Next, as in step S1103, the display panel transmits a constant voltage to all the pixel circuits to simultaneously drive all the pixel circuits during the display time.

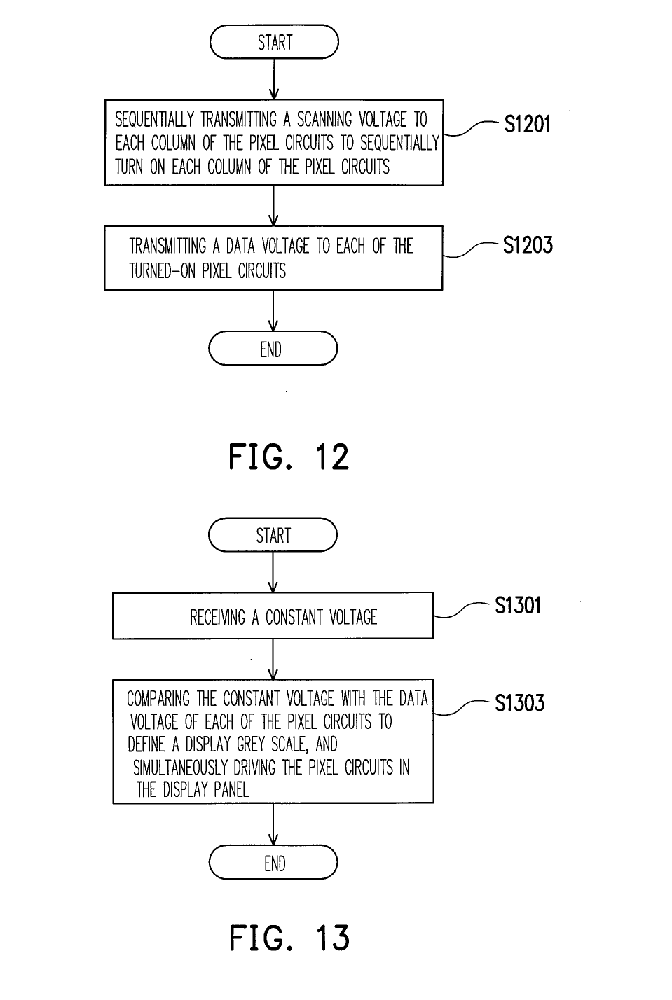

FIG. 12 is a flowchart illustrating the write time in the present embodiment. As described in step S1201, a scanning voltage is sequentially transmitted to each column of pixel circuits to sequentially turn on each column of pixel circuits. Next, as described in step S1203, a data voltage is transmitted to each turned-on pixel circuit.

FIG. 13 is a flowchart illustrating the display time in the present embodiment. As described in step S1301, a constant voltage is received. Next, as in step S1303, the constant voltage is compared with the data voltage of each pixel circuit to define a display grey scale, and at the same time the constant voltage drives each pixel circuit in the display panel.

According to the flowchart which illustrates the driving method of display panel in the present embodiment, whether a pixel circuit is in the write time or in the display time is determined according to a voltage level state of the scanning voltage. The display panel is in the write time when the voltage level state is a high voltage level, and the display panel is in the display time when the voltage level state is a low voltage level.

In overview, a pixel circuit, a display, and the driving method thereof are provided in the present invention. The present invention has following advantages:

1. the threshold voltage of the driving transistor is compensated.

2. the pixel aperture ratio of the display panel is improved.

3. the fabricating process is simplified.

4. the display uniformity of the display panel is improved.

5. the lifetime of the display panel is extended.

It will be apparent to those skilled in the art that various modifications and variations can be made to the structure of the present invention without departing from the scope or spirit of the invention. In view of the foregoing, it is intended that the present invention covers modifications and variations thereof provided they fall within the scope of the following claims.

What is claimed is:

1. A pixel circuit, comprising:
a first transistor having a first source/drain coupled to a supply voltage and a gate receiving a scanning voltage;
a coupling capacitor having a first terminal for receiving a data voltage and a second terminal coupled to the second source/drain of the first transistor;
a second transistor having a gate coupled to the second terminal of the coupling capacitor and a first source/drain coupled to the supply voltage; and
a luminescent element having a positive electrode coupled to the second source/drain of the second transistor and a grounded negative electrode.

2. The pixel circuit as claimed in claim 1, wherein the first transistor and the second transistor are fabricated by amorphous silicon, polysilicon, or microcrystalline silicon.

3. The pixel circuit as claimed in claim 1, wherein the first transistor and the second transistor comprise N-type thin film transistors.

4. The pixel circuit as claimed in claim 1, wherein the luminescent element is an organic light emitting diode (OLED).

5. A pixel circuit, comprising:
a luminescent element having a positive electrode coupled to a supply voltage and a negative electrode;
a first transistor having a first source/drain coupled to the negative electrode and a gate receiving a scanning voltage;
a coupling capacitor having a first terminal for receiving a data voltage, and a second terminal coupled to the second source/drain of the first transistor; and
a second transistor having a gate coupled to the second terminal of the coupling capacitor, a first source/drain coupled to the negative electrode, and a second source/drain grounded.

6. The pixel circuit as claimed in claim 5, wherein the first transistor and the second transistor are fabricated by amorphous silicon, polysilicon, or microcrystalline silicon.

7. The pixel circuit as claimed in claim 5, wherein the first transistor and the second transistor comprise N-type thin film transistors.

8. The pixel circuit as claimed in claim 5, wherein the luminescent element is an organic light emitting diode.

9. A pixel circuit, comprising:
a luminescent element having a positive electrode coupled to a supply voltage and a negative electrode;
a first transistor having a first source/drain coupled to the negative electrode and a second source/drain grounded;
a coupling capacitor having a first terminal for receiving a data voltage and a second terminal coupled to the gate of the first transistor; and
a second transistor having a gate receiving a scanning voltage, a first source/drain coupled to the second terminal of the coupling capacitor, and a second source/drain grounded.

10. The pixel circuit as claimed in claim 9, wherein the first transistor and the second transistor are fabricated by amorphous silicon, polysilicon, or microcrystalline silicon.

11. The pixel circuit as claimed in claim 9, wherein the first transistor and the second transistor comprise P-type thin film transistors.

12. The pixel circuit as claimed in claim 9, wherein the luminescent element is an organic light emitting diode.

13. A pixel circuit, comprising:
a luminescent element having a positive electrode and a grounded negative electrode;
a first transistor having a first source/drain coupled to a supply voltage and a second source/drain coupled to the positive electrode;
a coupling capacitor having a first terminal for receiving a data voltage and a second terminal coupled to the gate of the first transistor; and
a second transistor having a gate receiving a scanning voltage, a first source/drain coupled to the second terminal of the coupling capacitor, and a second source/drain coupled to the positive electrode.

14. The pixel circuit as claimed in claim 13, wherein the first transistor and the second transistor are fabricated by amorphous silicon, polysilicon, or microcrystalline silicon.

15. The pixel circuit as claimed in claim 13, wherein the first transistor and the second transistor comprise P-type thin film transistors.

16. The pixel circuit as claimed in claim 13, wherein the luminescent element is an organic light emitting diode.

17. A display, comprising:
a gate driving device having a plurality of gate lines for receiving a basic timing, the gate driving device sequentially outputting a scanning voltage to each of the gate lines;
a source driving device having a plurality of source lines for receiving an image data, the source driving device outputting a data voltage through the source lines;
a system switch coupled to a supply voltage; and
a display panel coupled to the gate driving device and the source driving device, the display panel having a plurality of pixel circuits, the pixel circuits being respectively disposed at the intersections of the gate lines and the source lines, each of the pixel circuits comprising:
a first transistor having a first source/drain coupled to a supply voltage through the system switch and a gate receiving the scanning voltage through one of the gate lines;
a coupling capacitor having a first terminal for receiving the data voltage through one of the source lines and a second terminal coupled to the second source/drain of the first transistor;
a second transistor having a gate coupled to the second terminal of the coupling capacitor and a first source/drain coupled to the supply voltage through the system switch; and
a luminescent element having a positive electrode coupled to the second source/drain of the second transistor and a grounded negative electrode,
wherein the system switch determines whether to send the supply voltage to the first sources/drains of all the second transistors in the display panel according to the voltage level state of the scanning voltage.

18. The display as claimed in claim 17, wherein the first transistor and the second transistor comprise N-type thin film transistors.

19. The display as claimed in claim 17, wherein the first transistor and the second transistor are fabricated by amorphous silicon, polysilicon, or microcrystalline silicon.

20. The display as claimed in claim 17, wherein the luminescent element is an organic light emitting diode.

21. The display as claimed in claim 17, wherein the system switch is adapted to send the supply voltage to the first sources/drains of all the second transistors in the display panel when the scanning voltage is a low voltage level.

22. The display as claimed in claim 17, wherein the time when the display panel displays an image data is divided into a write time and a display time, and wherein the display does not display image during the write time, and the display panel displays image during the display time.

23. The display as claimed in claim 22, wherein during the write time, the source driving device provides a data voltage to the pixel circuits to define the voltages stored in the coupling capacitors.

24. The display as claimed in claim 22, wherein during the display time, the source driving device provides a constant voltage to simultaneously drive the pixel circuits in the display panel.

25. A display, comprising:
a gate driving device having a plurality of gate lines for receiving a basic timing, the gate driving device sequentially outputting a scanning voltage to each of the gate lines;
a source driving device having a plurality of source lines for receiving an image data, the source driving device outputting a data voltage through the source lines;
a system switch coupled to a supply voltage; and
a display panel coupled to the gate driving device and the source driving device, the display panel having a plurality of pixel circuits, the pixel circuits being respectively disposed at the intersections of the gate lines and the source lines, each of the pixel circuits comprising:
a luminescent element having a positive electrode coupled to a supply voltage and a negative electrode;
a first transistor having a first source/drain coupled to the negative electrode and a gate receiving a scanning voltage;
a coupling capacitor having a first terminal for receiving a data voltage and a second terminal coupled to the second source/drain of the first transistor; and
a second transistor having a gate coupled to the second terminal of the coupling capacitor, a first source/drain coupled to the negative electrode, and a second source/drain grounded.

26. The display as claimed in claim 25, wherein the first transistor and the second transistor comprise N-type thin film transistors.

27. The display as claimed in claim 25, wherein the first transistor and the second transistor are fabricated by amorphous silicon, polysilicon, or microcrystalline silicon.

28. The display as claimed in claim 25, wherein the luminescent element is an organic light emitting diode.

29. The display as claimed in claim 25, wherein the system switch is adapted to send the supply voltage to the first sources/drains of all the second transistors in the display panel when the scanning voltage is a low voltage level.

30. The display as claimed in claim 25, wherein the time when the display panel displays an image data is divided into a write time and a display time, and wherein the display panel does not display image during the write time, and the display panel displays image during the display time.

31. The display as claimed in claim 30, wherein during the write time, the source driving device provides a data voltage to the pixel circuits to define the voltages stored in the coupling capacitors.

32. The display as claimed in claim 30, wherein during the display time, the source driving device provides a constant voltage to simultaneously driving the pixel circuits in the display panel.

33. A display, comprising:
a gate driving device having a plurality of gate lines for receiving a basic timing, the gate driving device sequentially outputting a scanning voltage to each of the gate lines;
a source driving device having a plurality of source lines for receiving an image data, the source driving device outputting a data voltage through the source lines;
a system switch coupled to a supply voltage; and
a display panel coupled to the gate driving device and the source driving device, the display panel having a plurality of pixel circuits, the pixel circuits being respectively disposed at the intersections of the gate lines and the source lines, each of the pixel circuits comprising:
a luminescent element having a positive electrode coupled to a supply voltage and a negative electrode;
a first transistor having a first source/drain coupled to the negative electrode and a second source/drain grounded;
a coupling capacitor having a first terminal for receiving a data voltage and a second terminal coupled to the gate of the first transistor; and
a second transistor having a gate receiving a scanning voltage, a first source/drain coupled to the second terminal of the coupling capacitor, and a second source/drain grounded.

34. The display as claimed in claim 33, wherein the first transistor and the second transistor comprise P-type thin film transistors.

35. The display as claimed in claim 33, wherein the first transistor and the second transistor are fabricated by amorphous silicon, polysilicon, or microcrystalline silicon.

36. The display as claimed in claim 33, wherein the luminescent element is an organic light emitting diode.

37. The display as claimed in claim 33, wherein the system switch is adapted to send the supply voltage to the first sources/drains of all the second transistors in the display panel when the scanning voltage is a low voltage level.

38. The display as claimed in claim 33, wherein the time when the display panel displays an image data is divided into a write time and a display time, and wherein the display panel does not display image during the write time, while the display panel displays image during the display time.

39. The display as claimed in claim 38, wherein during the write time, the source driving device provides a data voltage to the pixel circuits to define the voltages stored in the coupling capacitors.

40. The display as claimed in claim 38, wherein during the display time, the source driving device provides a constant voltage to simultaneously drive the pixel circuits in the display panel.

41. A display, comprising:
a gate driving device having a plurality of gate lines for receiving a basic timing, the gate driving device sequentially outputting a scanning voltage to each of the gate lines;
a source driving device having a plurality of source lines for receiving an image data, the source driving device outputting a data voltage through the source lines;
a system switch coupled to a supply voltage; and
a display panel coupled to the gate driving device and the source driving device, the display panel having a plurality of pixel circuits, the pixel circuits being respectively disposed at the intersections of the gate lines and the source lines, each of the pixel circuits comprising:
a luminescent element having a positive electrode and a grounded negative electrode;
a first transistor having a first source/drain coupled to a supply voltage and a second source/drain coupled to the positive electrode;
a coupling capacitor having a first terminal for receiving a data voltage and a second terminal coupled to the gate of the first transistor; and
a second transistor having a gate receiving a scanning voltage, a first source/drain coupled to the second terminal of the coupling capacitor, and a second source/drain coupled to the positive electrode.

42. The display as claimed in claim 41, wherein the first transistor and the second transistor comprise P-type thin film transistors.

43. The display as claimed in claim 41, wherein the first transistor and the second transistor are fabricated by amorphous silicon, polysilicon, or microcrystalline silicon.

44. The display as claimed in claim 41, wherein the luminescent element is an organic light emitting diode.

45. The display as claimed in claim 41, wherein the system switch comprises a MOS transistor, a diode, or a thin film transistor.

46. The display as claimed in claim 41, wherein the system switch is adapted to send the supply voltage to the first sources/drains of all the second transistors in the display panel when the scanning voltage is a low voltage level.

47. The display as claimed in claim 41, wherein the time when the display panel displays an image data is divided into a write time and a display time, and wherein the display panel does not display image during the write time, while the display panel displays image during the display time.

48. The display as claimed in claim 47, wherein during the write time, the source driving device provides a data voltage to the pixel circuits to define the voltages stored in the coupling capacitors.

49. The display as claimed in claim 47, wherein during the display time, the source driving device provides a constant voltage to simultaneously drive the pixel circuits in the display panel.

50. A method for driving a display panel, wherein the display panel has a plurality of pixel circuits arranged in an array, the driving method comprising:
when the display panel operating in a write time, the display panel sequentially turning on each of the enabled pixel circuits and transmitting a data voltage to the pixel circuits; and
when the display panel operating in a display time, the display panel transmitting a constant voltage to all the pixel circuits to simultaneously drive the pixel circuits.

51. The driving method as claimed in claim 50, further comprising the following steps during the write time:
sequentially transmitting the scanning voltage to each column of the pixel circuits to sequentially turn on each column of the pixel circuits; and
transmitting the data voltage to the turned-on pixel circuits.

52. The driving method as claimed in claim 50, further comprising the following steps during the display time:
receiving the constant voltage; and
comparing the constant voltage and the data voltage of each of the pixel circuits to define a display grey scale, and simultaneously driving the pixel circuits in the display panel.

53. The driving method as claimed in claim 50, wherein whether the write time or the display time of the pixel circuits is determined according to a voltage level state of the scanning voltage, and wherein the display panel is in the write time while the voltage level state is a high voltage level, and the display panel is in the display time while the voltage level state is a low voltage level.
